(19) United States
(12) Patent Application Publication
(10) Pub. No.: US 2026/0362075 A1
(43) Pub. Date: Nov. 12, 2026

(54) ACOUSTIC INFORMATION GENERATING DEVICE, METHOD AND PROGRAM

(71) Applicant: NTT, Inc., Tokyo (JP)

(72) Inventors: Kenta IMAIZUMI, Tokyo (JP); Kimitaka TSUTSUMI, Tokyo (JP); Shinji FUKATSU, Tokyo (JP)

(73) Assignee: NTT, Inc., Tokyo (JP)

(21) Appl. No.: 19/125,833

(22) PCT Filed: Nov. 2, 2022
(86) PCT No.: PCT/JP2022/040990

§ 371 Date: Apr. 30, 2025

(51) Int. Cl. H04S 7/00

(52) U.S. Cl. CPC H04S 7/303; H04S 2400/11; H04S 2400/15

(57) ABSTRACT

One aspect of the present invention acquires first acoustic information generated in a real target space and generates sound source information corresponding to each of a plurality of spatial areas forming a virtual space corresponding to the target space on the basis of the acquired first acoustic information. Then, the one aspect acquires information indicating a position of a user in the target space, generates second acoustic information for reproducing an acoustic space corresponding to the position of the user in the virtual space on the basis of the information indicating the position of the user and the sound source information, and outputs the generated second acoustic information.

### TECHNICAL FIELD

One aspect of the present invention relates to an acoustic information generation device, method, and program used for reproducing an acoustic space, for example.

### BACKGROUND ART

In recent years, services that provide point cloud data of cities, buildings, and the like acquired by using a laser scanner or the like have been widely used. Further, services that provide experience content based on a live-action video, such as an indoor cycling service that allows a person to re-experience a course in which another person has run by bicycle, have also started to be used. Those services can accurately reproduce a video space in which a video related to a scene of a real space is reflected. However, a technique of reproducing an acoustic space corresponding thereto has not yet been established.

In general, in order to reproduce video/acoustic spaces on a live-action basis, it is necessary to acquire video information and acoustic information in a target space. As a method of acquiring the acoustic information among those pieces of information, there is known a sound field collection technique disclosed in Patent Literature 1, for example. The technique acquires spatial acoustic information by using a spherical microphone array in which a plurality of microphones is arranged in a spherical shape.

However, this method requires enormous time and labor to acquire acoustic information in a wide space such as a space including cities, buildings, and the like. Further, it is possible to reproduce an acoustic space on the basis of the collected acoustic information in an area where the microphones are arranged, but it is difficult to accurately reproduce an acoustic space in an area where sound collection cannot be sufficiently performed, such as an area between areas where the microphones are arranged.

In a live-action-based experience content service such as an indoor cycling service that allows a person to re-experience a course in which another person has run by bicycle, a position of a user in a video space changes depending on the user's behavior such as pedaling. In this case, the pitch of sound to be reproduced changes according to a reproduction speed of a video, and the sound becomes uncomfortable.

Meanwhile, for example, Non Patent Literature 1 discloses an acoustic reproduction technique of correcting a change in pitch on the basis of a frequency spectrum of sound. However, in content in which the user may stop such as the content of the indoor cycling service, a video stops at the same time as the user stops, and thus sound becomes silent.

### CITATION LIST

### Patent Literature

Patent Literature 1: JP 2020-88561 A

### Non Patent Literature

Non Patent Literature 1: Michael R. Portnoff “Implementation of the Digital Phase Vocoder using the Fast Fourier Transform.” IEEE Transactions on Acoustics, Speech, and Signal Processing 24.3 (1976): 243-248.

### SUMMARY OF INVENTION

### Technical Problem

As described above, when reproducing an acoustic space corresponding to an arbitrary area in a wide target space, reproduction accuracy thereof depends on arrangement positions of microphones, and, in a case where a position of a user in a video space changes, it is necessary to change the acoustic space according to the position of the user.

The present invention has been made in view of the above circumstances, and an object thereof is to provide a technique capable of, even if a target space is wide or a user exists at any position in the target space, accurately reproducing acoustic information at the position.

### Solution to Problem

In order to solve the above problems, one aspect of an acoustic information generation device or generation method according to the present invention acquires first acoustic information generated in a real target space and generates sound source information corresponding to each of a plurality of spatial areas forming a virtual space corresponding to the target space on the basis of the acquired first acoustic information. Then, the acoustic information generation device or generation method acquires information indicating a position of a user in the virtual space, generates second acoustic information for reproducing an acoustic space corresponding to the position of the user on the basis of the acquired information indicating the position of the user and the sound source information, and outputs the generated second acoustic information.

According to one aspect of the present invention, even in a case where the first acoustic information in the real target space is acquired by a small number of microphones, the sound source information corresponding to each of the plurality of spatial areas forming the virtual space corresponding to the target space is generated on the basis of the first acoustic information. Then, the second acoustic information for reproducing the acoustic space corresponding to the position of the user in the virtual space is generated on the basis of a positional relationship between the acquired position of the user in the virtual space and the plurality of spatial areas. Therefore, even if the virtual space is wide, the sound source information of the entire area can be generated, and, even if the user exists at any position in the virtual space, the second acoustic information corresponding to the existence position of the user can be accurately generated.

### Advantageous Effects of Invention

That is, according to one aspect of the present invention, it is possible to provide a technique capable of, even if a virtual space corresponding to a target space is wide or a user exists at any position in the virtual space, accurately reproducing acoustic information at the position of the user on the basis of acoustic information collected in a real target space.

### BRIEF DESCRIPTION OF DRAWINGS

FIG. 1 shows an example of a configuration of an acoustic space reproduction system including an acoustic information generation device according to an embodiment of the present invention.

FIG. 2 is a block diagram showing an example of a hardware configuration of an acoustic information generation device according to an embodiment of the present invention.

FIG. 3 is a block diagram showing an example of a software configuration of an acoustic information generation device according to an embodiment of the present invention.

FIG. 4 is a flowchart showing an example of a processing procedure and processing contents of acoustic space reproduction processing executed by a control unit of the acoustic information generation device in FIG. 3.

FIG. 5 is a flowchart showing an example of a processing procedure and processing contents of sound source design processing in the processing procedure of FIG. 4.

FIG. 6 is a flowchart showing an example of a processing procedure and processing contents of weighting coefficient determination processing in the processing procedure of FIG. 4.

FIG. 7 shows an example of a configuration of spatial areas into which a target space is divided and a moving route of a user.

### DESCRIPTION OF EMBODIMENTS

Hereinafter, embodiments according to the present invention will be described with reference to the drawings.

### Embodiment

### Configuration Example

### (1) System

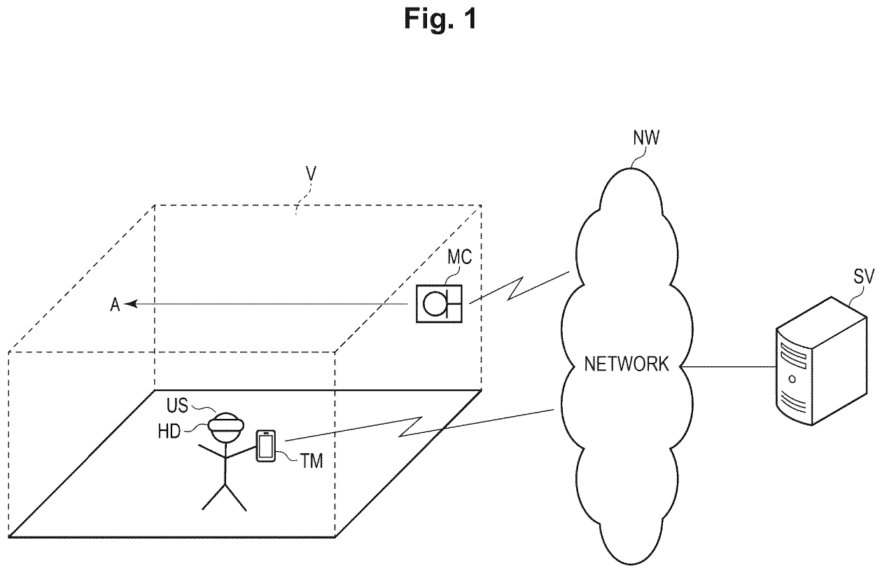

FIG. 1 shows an example of a configuration of an acoustic space reproduction system according to an embodiment of the present invention.

The acoustic space reproduction system according to the embodiment includes an acoustic information generation device SV as a core thereof. The acoustic information generation device SV includes, for example, a server computer arranged on the web or a cloud.

In a real target space V, a microphone unit MC is arranged in a movable state. The microphone unit MC collects sounds including a voice, a background sound, and the like generated in the target space V and can communicate with the acoustic information generation device SV via a network NW.

A user US can freely move in the target space V. The user US possesses a user terminal TM such as a smartphone or a wearable terminal and wears a head mounted display (HMD) HD. The user terminal TM can communicate with the acoustic information generation device SV via the network NW. The head mounted display HD can communicate with the acoustic information generation device SV directly via the network NW or via the user terminal TM.

The microphone unit MC includes a microphone and a communication device. The microphone collects sounds including a voice, a background sound, and the like generated in the real target space V and outputs acoustic signals thereof. The communication device transmits the acoustic signals output from the microphone to the acoustic information generation device SV via the network NW.

The user terminal TM has a position measurement function using, for example, a global positioning system (GPS), detects a sound generation position in the real space by using the position measurement function, and transmits the detected position information to the acoustic information generation device SV via the network NW. The head mounted display HD includes a speaker in addition to a display, receives an acoustic signal transmitted from the acoustic information generation device SV, and presents a reproduced acoustic space to the user.

Instead of the head mounted display HD, a plurality of speakers may be dispersedly arranged in the real target space V, and the acoustic information generation device SV may transmit an acoustic signal to a speaker corresponding to a position of the user US among the plurality of speakers and present an acoustic space.

The network NW includes, for example, a wide area network having the Internet as a core and an access network for accessing the wide area network. Note that the network NW may be a local network configured by a local area network (LAN) using wired or wireless communication.

### (2) Acoustic Information Generation Device SV

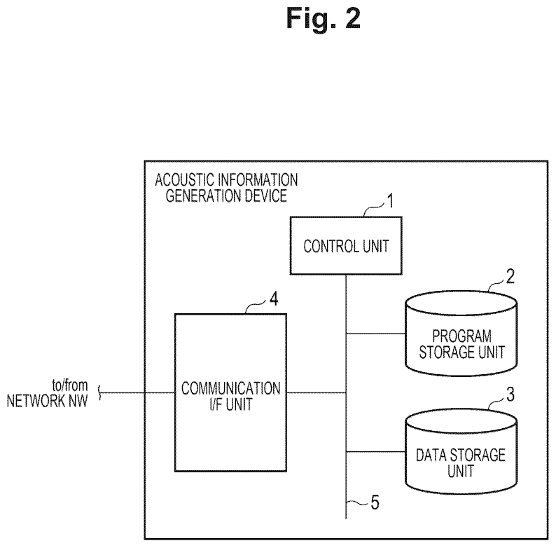

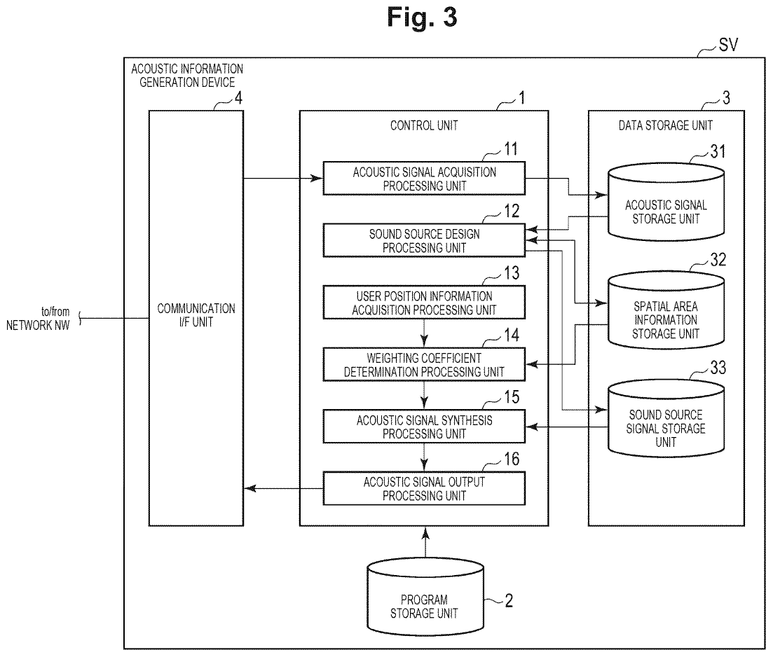

FIGS. 2 and 3 are block diagrams showing examples of a hardware configuration and a software configuration of the acoustic information generation device SV according to the embodiment of the present invention.

The acoustic information generation device SV includes a control unit 1 including a hardware processor such as a central processing unit (CPU), and the control unit 1 is connected to a storage unit including a program storage unit 2 and a data storage unit 3 and a communication interface (hereinafter, interface will be abbreviated as I/F) unit 4 via a bus 5. Note that the acoustic information generation device SV may be not only a server computer, but also a personal computer.

The communication I/F unit 4 receives an acoustic signal transmitted from the microphone unit MC according to a communication protocol defined by the network NW. The communication I/F unit 4 also receives position information of the user transmitted from the user terminal TM and transmits an acoustic signal generated by the control unit 1 to the head mounted display HD.

For example, the program storage unit 2 is configured by combining a nonvolatile memory capable of performing writing and reading as needed, such as a solid state drive (SSD), with a nonvolatile memory such as a read only memory (ROM) as a storage medium and stores not only middleware such as an operating system (OS), but also application programs necessary for executing various types of control processing according to the embodiment. Hereinafter, the OS and the application programs will be collectively referred to as programs.

The data storage unit 3 is, for example, a combination of a nonvolatile memory capable of performing writing and reading as needed, such as an SSD, and a volatile memory such as a random access memory (RAM) as a storage medium, and, in a storage area thereof, an acoustic signal storage unit 31, a spatial area information storage unit 32, and a sound source signal storage unit 33 are provided.

The acoustic signal storage unit 31 is used for storing an acoustic signal in the real target space V transmitted from the microphone unit MC. The spatial area information storage unit 32 stores information indicating a plurality of spatial areas obtained by dividing a virtual space corresponding to the real target space V by a predetermined size such that the divided spatial areas do not overlap each other. The information indicating the spatial areas includes identification information and position information of the spatial areas. The sound source signal storage unit 33 is used for storing a sound source signal generated by the control unit 1 for each of the plurality of spatial areas.

The control unit 1 includes an acoustic signal acquisition processing unit 11, a sound source design processing unit 12, a user position information acquisition processing unit 13, a weighting coefficient determination processing unit 14, an acoustic signal synthesis processing unit 15, and an acoustic signal output processing unit 16 as processing functions necessary for implementing the embodiment. Those processing units 11 to 16 are all implemented by causing the hardware processor of the control unit 1 to execute the application programs stored in the program storage unit 2.

Some or all of the processing units 11 to 16 may be implemented by using hardware such as large scale integration (LSI) or an application specific integrated circuit (ASIC).

The acoustic signal acquisition processing unit 11 receives an acoustic signal of the real target space V transmitted from the microphone unit MC via the communication I/F unit 4 and stores the received acoustic signal of the target space V together with information indicating a sound collection position and a sound collection time or reception time thereof in the acoustic signal storage unit 31 as first acoustic information.

The sound source design processing unit 12 generates a sound source signal corresponding to each of a plurality of spatial areas forming a virtual space corresponding to the target space V on the basis of the acoustic signal of the real target space V stored in the acoustic signal storage unit 31 and stores each generated sound source signal in the sound source signal storage unit 33 in association with the identification information of the spatial areas. Note that an example of processing of generating the sound source signal will be described in an operation example.

The user position information acquisition processing unit 13 acquires position information of the user US in the virtual space corresponding to the target space V, for example, a position of an avatar corresponding to the user US. The position information can be acquired from coordinates in the virtual space.

Based on the position information of the user US and the position information of each spatial area stored in the spatial area information storage unit 32, the weighting coefficient determination processing unit 14 determines a weighting coefficient that reflects a positional relationship between the user and each spatial area in the sound source signal of each spatial area. Note that an example of processing of determining the weighting coefficient will also be described in the operation example.

Based on the weighting coefficient determined by the weighting coefficient determination processing unit 14 and the sound source signal of the spatial area stored in the sound source signal storage unit 33, the acoustic signal synthesis processing unit 15 generates an acoustic signal for reproducing an acoustic space in a spatial area corresponding to the position of the user in the virtual space. An example of processing of generating the acoustic signal will also be described in the operation example.

The acoustic signal output processing unit 16 transmits the acoustic signal generated by the acoustic signal synthesis processing unit 15 from the communication I/F unit 4 to the head mounted display HD of the user US.

### Operation Example

Next, an operation example of the acoustic information generation device SV configured as described above will be described.

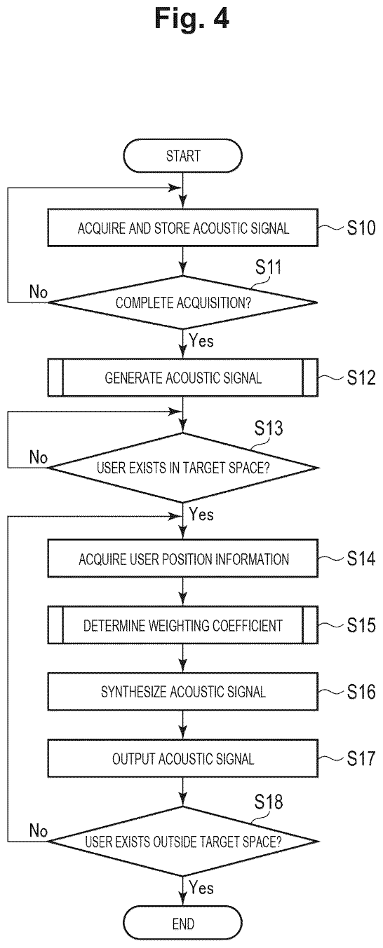

FIG. 4 is a flowchart showing an example of acoustic space reproduction processing executed by the control unit 1 of the acoustic information generation device SV.

### (1) Design of Sound Source in a Plurality of Spatial Areas Forming Virtual Space Corresponding to Real Target Space V

### (1-1) Acquisition of Acoustic Signal

First, in step S10, the control unit 1 of the acoustic information generation device SV executes processing of acquiring an acoustic signal generated in the real target space V under the control of the acoustic signal acquisition processing unit 11.

As a method of acquiring an acoustic signal in the real target space V, there are a method of acquiring sound in the target space V by moving one microphone and a method of acquiring sound in the target space V by dispersedly arranging a plurality of microphones in the target space V.

Among those methods, first, the method of moving a microphone is performed as shown in FIG. 1, for example. That is, one microphone unit MC is moved at a constant speed in an arrow A direction from one end to the other end of the target space V, and sounds including a voice, a background sound, and the like in the target space V are collected by the microphone unit MC during this movement. Then, acoustic signals corresponding to the collected sounds including the voice, the background sound, and the like are received by the communication I/F unit 4 from the microphone unit MC via the network NW, and the received acoustic signals are stored in the acoustic signal storage unit 31 together with information indicating sound collection times and sound collection positions thereof.

Meanwhile, in the method using a plurality of microphones dispersedly arranged in the target space V, for example, the target space V is divided into a plurality of spatial areas, and microphones are arranged in the plurality of divided spatial areas, respectively. Then, acoustic signals corresponding to sounds in the respective spatial areas collected by the microphones are received by the communication I/F unit 4 via the network NW, and the received acoustic signals are stored in the acoustic signal storage unit 31 together with information indicating sound collection times and sound collection positions thereof.

In step S11, the acoustic signal acquisition processing unit 11 determines whether or not acquisition of acoustic signals in the entire target space V has been completed and continues the acoustic signal acquisition processing in step S10 until the acquisition is completed.

### (1-2) Design of Sound Source

Next, in step S12, the control unit 1 of the acoustic information generation device SV designs a sound source in each spatial area forming the virtual space corresponding to the real target space V under the control of the sound source design processing unit 12 as follows.

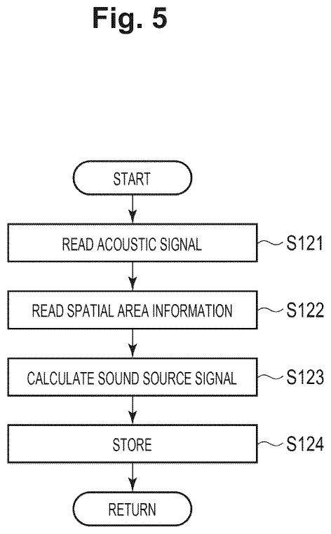

FIG. 5 is a flowchart showing an example of a processing procedure and processing contents of sound source design processing executed by the sound source design processing unit 12.

That is, the sound source design processing unit 12 first reads an acoustic signal from the acoustic signal storage unit 31 in step S121 and further reads spatial area information from the spatial area information storage unit 32 in step S122. The spatial area information includes identification information and position information of the plurality of spatial areas generated by dividing the virtual space corresponding to the target space V by a predetermined size such that the divided spatial areas do not overlap each other.

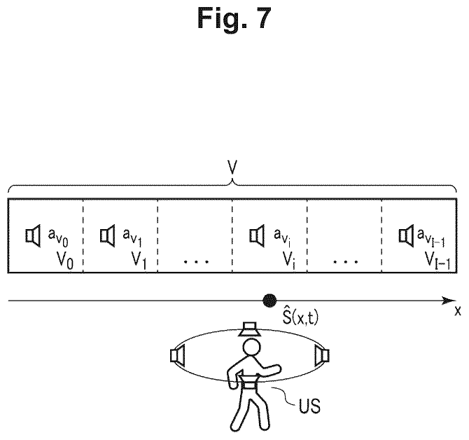

Here, assuming that the virtual space corresponding to the target space V is divided into I pieces in the one-dimensional direction A as shown in FIG. 7, for example, each spatial area Vᵢ at this time is expressed as follows.

Vᵢ⊂V (0≤i<I) Note that the virtual space corresponding to the target space V may be configured by a plurality of spatial areas divided in a two-dimensional direction or a three-dimensional direction.

In step S123, the sound source design processing unit 12 generates a sound source signal corresponding to each spatial area Vᵢ on the basis of a relationship between a sound collection position of the read acoustic signal and a position of each spatial area Vᵢ.

For example, in a case where an acoustic signal S(t) is acquired by using one movable microphone unit MC in the acoustic signal acquisition processing described above, the sound source design processing unit 12 acquires a sound source signal aVᵢ (t) corresponding to each spatial area Vᵢ by using the following expressions.

$${a}_{{V}_{i}} ( t ) = S ( {t}_{{V}_{i}}^{b} + {t}_{{V}_{i}}^{′} ) , \qquad [ Math . 1 ]$$

$${t}_{{V}_{i}}^{′} = t \% ( {t}_{{V}_{i}}^{e} - {t}_{{V}_{i}}^{b} ) .$$

Here, t^{b}Vᵢ and t^{e}Vᵢ represent a sound collection start time and a sound collection end time of the acoustic signal S(t), respectively, and % represents a remainder operator.

Meanwhile, in a case where acoustic signals of the target space V are acquired by using the plurality of microphones arranged in respective areas corresponding to the spatial areas Vᵢ of the target space V, the sound source design processing unit 12 generates a sound source signal aVᵢ (t) corresponding to each spatial area Vᵢ by using the following expressions.

$${a}_{{V}_{i}} ( t ) = {S}_{{V}_{i}} ( {t}_{{V}_{i}}^{′} ) , \qquad [ Math . 2 ]$$

$${t}_{{V}_{i}}^{′} = t \% {t}_{{V}_{i}}^{e} .$$

Here, SVᵢ (t) represents an acoustic signal collected by the microphone arranged at a position in each area of the target area corresponding to each spatial area Vᵢ.

In step S124, the sound source design processing unit 12 stores the sound source signal aVᵢ(t) of each spatial area Vᵢ generated as described above in the sound source signal storage unit 33. Note that the sound source signal aVᵢ(t) in each spatial area Vᵢ is a signal obtained by repeating an acoustic signal collected in each spatial area Vᵢ.

### (2) Generation of Acoustic Signal Corresponding to User Position in Virtual Space

### (2-1) Acquisition of Position Information of User in Virtual Space

First, in step S13, the control unit 1 of the acoustic information generation device SV determines whether or not the user exists in the virtual space corresponding to the target space V. Then, when determining that the user US exists in the virtual space, in step S14, the control unit acquires position information x of the user US from the coordinates of the virtual space under the control of the user position information acquisition processing unit 13.

### (2-2) Determination of Weighting Coefficient

When acquiring the position information x of the user US in the virtual space, in step S15, the control unit 1 of the acoustic information generation device SV then determines a weighting coefficient CVᵢ(x) to be given to the sound source signal aVᵢ (t) of each spatial area Vᵢ under the control of the weighting coefficient determination processing unit 14.

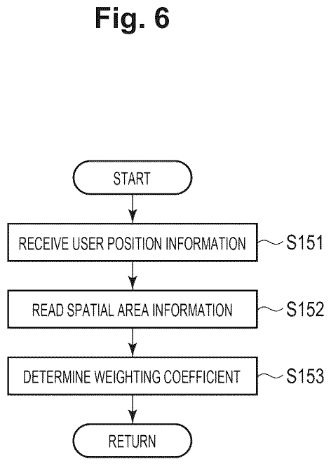

FIG. 6 is a flowchart showing an example of a processing procedure and processing contents executed by the weighting coefficient determination processing unit 14.

First, in step S151, the weighting coefficient determination processing unit 14 receives the position information x of the user US in the virtual space from the user position information acquisition processing unit 13. In step S152, the weighting coefficient determination processing unit also reads the position information of each spatial area Vᵢ into which the virtual space is divided from the spatial area information storage unit 32.

Next, in step S153, the weighting coefficient determination processing unit 14 determines the weighting coefficient CVᵢ (x) to be given to the sound source signal aVᵢ (t) corresponding to each spatial area Vᵢ on the basis of a positional relationship between the position information of the user US and the position information of each spatial area Vᵢ. For example, calculation is performed such that the weighting coefficient CVᵢ (x) becomes smaller as the spatial area Vᵢ is farther from the position x of the user US.

Specifically, the following calculation processing using a Hamming window is used.

$${c}_{{V}_{i}} ( x ) = \{ \begin{matrix}1 & if x ∈ {V}_{i} , \\ 0.5 - 0.5 cos ( 2 π \frac{{d}_{{V}_{i}} ( x )}{{x}_{{V}_{i}}} + π ) & if {d}_{{V}_{i}} ( x ) < {X}_{{V}_{i}} , \\ 0 & if {d}_{{V}_{i}} ( x ) > {X}_{{V}_{i}} .\end{matrix} \qquad [ Math . 3 ]$$

Here, x represents the position of the user, d(x) represents a distance between a boundary surface of the spatial area Vᵢ and the position x of the user US, and XVᵢ represents a maximum distance at which the sound source signal aVᵢ (t) of the spatial area Vᵢ reaches.

### (2-3) Synthesis of Acoustic Signal

Subsequently, in step S16, the control unit 1 of the acoustic information generation device SV generates an acoustic signal for reproducing an acoustic space corresponding to the position x of the user US in the virtual space under the control of the acoustic signal synthesis processing unit 15 as follows.

That is, the acoustic signal synthesis processing unit 15 reads the sound source signal aVᵢ (t) of each spatial area Vᵢ from the sound source signal storage unit 33. Then, the acoustic signal synthesis processing unit receives the weighting coefficient CVᵢ (x) of each spatial area Vᵢ from the weighting coefficient determination processing unit 14 and reflects the weighting coefficient CVᵢ (x) in the sound source signal aVᵢ (t), thereby generating an acoustic signal S\hat{ }(x, t) for reproducing the acoustic space corresponding to the position x of the user US in the virtual space.

The acoustic signal S\hat{ }(x, t) at this time is expressed as follows.

$$\hat{S} ( x , t ) = {\sum }_{i} {c}_{{V}_{i}} ( x ) {a}_{{V}_{i}} ( t ) \qquad [ Math . 4 ]$$

### (2-4) Output of Acoustic Signal

In step S17, the control unit 1 of the acoustic information generation device SV transmits the acoustic signal S\hat{ }(x, t) corresponding to the position x of the user US in the virtual space, which is generated by the acoustic signal synthesis processing unit 15, from the communication I/F unit 4 to the head mounted display HD of the user US under the control of the acoustic signal output processing unit 16. As a result, in the head mounted display HD, the acoustic signal S\hat{ }(x, t) is output from a speaker, whereby the acoustic space corresponding to the position x of the user US is reproduced in the virtual space.

That is, for example, as shown in FIG. 7, the acoustic space can be reproduced in the virtual space as if a voice or background sound generated at the position x of the user US is output from a virtual speaker array arranged at the position x so as to surround the user US.

In step S18, the control unit 1 of the acoustic information generation device SV determines whether or not the user US has moved out of the virtual space. Then, in a case where the user US stays in the virtual space, the control unit 1 repeatedly generates and outputs an acoustic signal corresponding to the user position x in steps S14 to S18. Therefore, when the user US moves in the virtual space, an acoustic space corresponding to the position x of the user US is reproduced according to a change in the position x.

Meanwhile, when determining that the user US has moved out of the virtual space, the control unit 1 ends the acoustic space reproduction processing for the user US.

### (Actions and Effects)

As described above, in one embodiment, the acoustic information generation device SV acquires an acoustic signal S(t) corresponding to a sound of the real target space V collected by the microphone unit MC and generates a sound source signal aVᵢ (t) for each of the plurality of spatial areas Vᵢ forming the virtual space corresponding to the target space V on the basis of the acquired acoustic signal S(t) and information indicating the spatial areas Vᵢ. Then, the acoustic information generation device acquires the position information x of the user US in the virtual space, determines the weighting coefficient CVᵢ (x) for the sound source signal aVᵢ (t) corresponding to each spatial area Vᵢ on the basis of a relationship between the acquired position x of the user US and a position of the spatial area Vᵢ generates an acoustic signal S\hat{ }(x, t) for reproducing an acoustic space corresponding to the position of the user US in the virtual space on the basis of the determined weighting coefficient CVᵢ(x) and the sound source signal aVᵢ (t), and outputs the acoustic signal to the head mounted display HD.

Therefore, even in a case where the acoustic signal S(t) in the real target space V is acquired by a small number of microphones, a sound source signal aVᵢ(t) corresponding to each of the plurality of spatial areas Vᵢ forming the virtual space corresponding to the target space V is generated on the basis of the acoustic signal S(t). Then, an acoustic signal S\hat{ }(x, t) for reproducing an acoustic space corresponding to the current position x of the user US in the virtual space is generated on the basis of a positional relationship between the acquired position x of the user US in the virtual space and the plurality of spatial areas Vᵢ. Therefore, even if the virtual space corresponding to the target space V is wide, it is possible to generate sound source signals aVᵢ(t) in the entire area, and, even if the user US exists at any position in the virtual space, it is possible to accurately generate an acoustic signal S\hat{ }(x, t) corresponding to the position x of the user US.

### Other Embodiments

(1) In the embodiment, there has been described an example where, after the processing of generating a sound source signal corresponding to each spatial area is performed, position information of the user US is acquired, and the processing of determining the weighting coefficient is performed. However, the present invention is not limited thereto, and the processing of determining the weighting coefficient corresponding to each spatial area may be performed after the position information of the user US is acquired, and then the processing of generating the sound source information corresponding to each spatial area may be executed.
(2) In the embodiment, an example where the acoustic information generation device SV is implemented by a server on a cloud or the web has been described. However, the acoustic information generation device may be implemented by a personal computer possessed by the user for each user. Further, the processing functions of the acoustic information generation device SV may also be dispersedly arranged in the server on the cloud or the web and the personal computer possessed by the user.
(3) In addition, a functional configuration of the acoustic information generation device, the processing procedure and processing contents thereof, the type of target space, the number, size, and shape of spatial areas, the method of collecting sounds in the target space, the method of presenting an acoustic signal for reproducing an acoustic space to the user, and the like can be variously modified and implemented without departing from the gist of the present invention.

Although the embodiments of the present invention have been described in detail, the description provided above is merely an example of the present invention in all respects. It is needless to say that various improvements and modifications can be made without departing from the scope of the present invention. That is, in implementing the present invention, specific configurations according to the embodiments may be appropriately adopted.

In short, the present invention is not limited to the embodiments without any change and can be embodied by modifying the components without departing from the gist of the present invention at the implementation stage. Further, various inventions can be made by appropriately combining the plurality of components disclosed in the embodiments. For example, some components may be removed from all the components described in the embodiments. Further, components in another embodiment may be appropriately combined.

Reference Signs List

| SV | Acoustic information generation device |
|---|---|
| MC | Microphone unit |
| TM | User terminal |
| HD | Head mounted display |
| NW | Network |
| 1 | Control unit |
| 2 | Program storage unit |
| 3 | Data storage unit |
| 4 | Communication I/F unit |
| 5 | Bus |
| 11 | Acoustic signal acquisition processing unit |
| 12 | Sound source design processing unit |
| 13 | User position information acquisition processing unit |
| 14 | Weighting coefficient determination processing unit |
| 15 | Acoustic signal synthesis processing unit |
| 16 | Acoustic signal output processing unit |
| 31 | Acoustic signal storage unit |
| 32 | Spatial area information storage unit |
| 33 | Sound source signal storage unit |

1. An acoustic information generation device comprising:
first processing circuitry that acquires first acoustic information generated in a real target space;
second processing circuitry that generates sound source information corresponding to each of a plurality of spatial areas forming a virtual space corresponding to the target space on the basis of the acquired first acoustic information;
third processing circuitry that acquires information indicating a position of a user in the virtual space;
fourth processing circuitry that generates second acoustic information for reproducing an acoustic space corresponding to the position of the user in the virtual space on the basis of the information indicating the position of the user and the sound source information; and
fifth processing circuitry that outputs the generated second acoustic information.

2. The acoustic information generation device according to claim 1, wherein:
the second processing circuitry divides the virtual space into the plurality of spatial areas and generates the sound source information corresponding to each of the plurality of spatial areas on the basis of information indicating a positional relationship between the plurality of divided spatial areas and a sound collection area of the first acoustic information; and
the fourth processing circuitry determines a weighting coefficient for the sound source information corresponding to the plurality of spatial areas on the basis of a positional relationship between the information indicating the position of the user in the virtual space and the plurality of spatial areas and generates the second acoustic information for reproducing the acoustic space corresponding to the position of the user in the virtual space on the basis of the sound source information corresponding to the plurality of spatial areas and the weighting coefficient determined for the plurality of spatial areas.

3. The acoustic information generation device according to claim 2, wherein:
the first processing circuitry acquires an acoustic signal S(t) output from a microphone that moves in the target space V as the first acoustic information; and
in a case where the virtual space corresponding to the target space V is divided into the plurality of spatial areas Vᵢ⊂V (0≤i<I) that are in contact with each other and do not overlap each other, the second processing circuitry generates the sound source information aVᵢ (t) for the spatial area Vᵢ by using the following expressions,
$${a}_{{V}_{i}} ( t ) = S ( {t}_{{V}_{i}}^{b} + {t}_{{V}_{i}}^{′} ) , \qquad [ Math . 1 ]$$
$${t}_{{V}_{i}}^{′} = t \% ( {t}_{{V}_{i}}^{e} - {t}_{{V}_{i}}^{b} ) .$$
where a sound collection start time and a sound collection end time of the acoustic signal S(t) in the spatial area Vᵢ are represented as t^{b}Vᵢ and t^{e}Vᵢ, respectively, and % represents a remainder operator.

4. The acoustic information generation device according to claim 2, wherein:
in a case where the virtual space is divided into the plurality of spatial areas Vᵢ⊂V (0≤i<I) that are in contact with each other and do not overlap each other, the first processing circuitry acquires, as the first acoustic information, an acoustic signal SVᵢ (t) output from a microphone arranged in each area corresponding to the spatial area Vᵢ of the target space; and
the second processing circuitry generates the sound source information aVᵢ (t) for the spatial area Vᵢ by using the following expressions,
$${a}_{{V}_{i}} ( t ) = {S}_{{V}_{i}} ( {t}_{{V}_{i}}^{′} ) , \qquad [ Math . 2 ]$$
$${t}_{{V}_{i}}^{′} = t \% {t}_{{V}_{i}}^{e} .$$
where a sound collection end time of the acoustic signal SVᵢ (t) in the spatial area Vᵢ is represented as t^{e}Vᵢ, and % represents a remainder operator.

5. The acoustic information generation device according to claim 2, wherein
the fourth processing circuitry
determines the weighting coefficient CVᵢ (x) for the sound source information aVᵢ (t) of the plurality of spatial areas Vᵢ by using the following expression,
$${c}_{{V}_{i}} ( x ) = \{ \begin{matrix}1 & if x ∈ {V}_{i} , \\ 0.5 - 0.5 cos ( 2 π \frac{{d}_{{V}_{i}} ( x )}{{x}_{{V}_{i}}} + π ) & if {d}_{{V}_{i}} ( x ) < {X}_{{V}_{i}} , \\ 0 & if {d}_{{V}_{i}} ( x ) > {X}_{{V}_{i}} .\end{matrix} \qquad [ Math . 3 ]$$
where a position of the user is represented as x, a distance between a boundary surface of the spatial area Vᵢ and the position x of the user is represented as d(x), and a maximum distance at which the sound source information of the spatial area Vᵢ reaches is represented as XVᵢ, and
generates the second acoustic information S\hat{ }(x, t) corresponding to the position x of the user on the basis of the sound source information aVᵢ (t) corresponding to the plurality of spatial areas Vᵢ and the weighting coefficient CVᵢ (x) determined for the plurality of spatial areas Vᵢ by using the following expression.
$$\hat{S} ( x , t ) = {\sum }_{i} {c}_{{V}_{i}} ( x ) {a}_{{V}_{i}} ( t ) \qquad [ Math . 4 ]$$

6. An acoustic information generation method, comprising:
acquiring first acoustic information generated in a real target space;
generating sound source information corresponding to each of a plurality of spatial areas forming a virtual space corresponding to the target space on the basis of the acquired first acoustic information;
acquiring information indicating a position of a user in the virtual space;
generating second acoustic information for reproducing an acoustic space corresponding to the position of the user in the virtual space on the basis of the information indicating the position of the user and the sound source information; and
outputting the generated second acoustic information.

7. A non-transitory computer readable medium storing a program for causing a processor included in the acoustic information generation device according to claim 1 to execute processing performed by at least one of the first to fifth processing circuitry included in the acoustic information generation device.
